(19) United States
(12) Patent Application Publication
(10) Pub. No.: US 2022/0322656 A1
(43) Pub. Date: Oct. 13, 2022

(54) PRESERVATION OF ORGANS FOR TRANSPLANT AND NON-TRANSPLANT SURGERIES

(71) Applicant: The Regents of the University of Michigan, Ann Arbor, MI (US)

(72) Inventors: Zhong Wang, Ann Arbor, MI (US); Paul C. Tang, Ann Arbor, MI (US); Yuqing Eugene Chen, Superior Township, MI (US); Betram Pitt, Ann Arbor, MI (US); Francis D. Pagani, Ann Arbor, MI (US); Ienglam Lei, Ann Arbor, MI (US)

(21) Appl. No.: 17/639,210

(22) PCT Filed: Aug. 28, 2020
(86) PCT No.: PCT/US2020/048442

§ 371 Date: Feb. 28, 2022

Related U.S. Application Data
(60) Provisional application No. 62/976,719, filed on Feb. 14, 2020.
(60) Provisional application No. 62/892,917, filed on Aug. 28, 2019.

(51) Int. Cl. A01N 1/02

(52) U.S. Cl. CPC A01N 1/0226

(57) ABSTRACT

Provided herein are organ preservation solutions and methods of use thereof for preserving organs. In particular, provided herein are preservation solutions comprising a mineralocorticoid receptor antagonist, aldehyde dehydrogenase agonist, and/or histone deacetylase inhibitor, and methods of perfusing and storing an organ while awaiting transplantation or non-transplant surgery.

### CROSS-REFERENCE TO RELATED APPLICATIONS

The present invention claims priority to U.S. Provisional Patent Application 62/892,917, filed Aug. 28, 2019, and U.S. Provisional Patent Application 62/976,719, filed Feb. 14, 2020,which is incorporated by reference in its entirety.

### FIELD

Provided herein are organ preservation solutions and methods of use thereof for preserving organs. In particular, provided herein are preservation solutions comprising a mineralocorticoid receptor antagonist, aldehyde dehydrogenase agonist, and/or histone deacetylase inhibitor, and methods of perfusing and storing an organ while awaiting transplantation or non-transplant surgery.

### BACKGROUND

Heart failure is a major health care challenge which impacts ˜6.5 million adults in the United States. Projected heart failure prevalence in the aging U.S. population will increase by 46% between 2012 and 2030 (Ref. 1; incorporated by reference in its entirety). While heart transplantation is the most effective therapeutic modality for end stage heart failure with a median survival of 10-15 years, a shortage in donor hearts exists due to demand exceeding supply. With well over 4,000 patients on the heart transplant waiting list in 2016 (Ref. 2; incorporated by reference in its entirety), less than 3000 heart transplants performed during the same period (Ref. 3; incorporated by reference in its entirety). An important reason for this donor heart shortage is that fewer than 50% of potential donors become actual heart donors (Ref. 4; incorporated by reference in its entirety). A therapeutic alternative is the implantation of a ventricular assist device implantation, but survival with this approach is unfortunately much inferior to that of heart transplantation. This is because of associated complications such as device failure, infection, thromboembolic events (e.g. strokes), and bleeding complications (e.g. gastrointestinal bleeding) (Ref. 5; incorporated by reference in its entirety). Furthermore, current median heart transplant survival is limited by chronic rejection and allograft vasculopathy to 10-15 years (Ref. 6; incorporated by reference in its entirety).

Donor hearts are not used often due to the concern over the risk factors for primary graft dysfunction (PGD). PGD is defined as poor donor heart contractility leading to inadequate cardiac output in the early postoperative period, and has a major negative impact on survival (Ref. 7; incorporated by reference in its entirety). While one month mortality following heart transplant is approximately 8%, 39% of these early deaths are from PGD which occurs in 10-20% of patients (Ref. 7; incorporated by reference in its entirety). Risk factors for PGD include increased graft ischemia time (e.g. geographic travel time constraints), older donor age, left ventricular hypertrophy, and high donor troponin (Ref. 8; incorporated by reference in its entirety). This may manifest as biventricular or single ventricular (often right ventricle) dysfunction (Ref. 4; incorporated by reference in its entirety). Treatment for cardiogenic shock from PGD may include support with high dose inotropic drugs to promote intrinsic contractility, ventricular assist devices/pumps, extracorporeal membrane oxygenation or retransplantation in the most severe cases (Ref. 7; incorporated by reference in its entirety). It is important to note that there is a 4-hour time window in which the preserved donor heart can be transported to the recipient for transplantation and reperfusion. This greatly limits the geographic area where the donor heart can be transported to benefit compatible transplant recipients (Ref. 9; incorporated by reference in its entirety).

Traditional preservation methods with mechanical arrest and cold preservation is known to incur tissue injury during preservation from associated tissue inflammation (Refs. 10-11; incorporated by reference in their entireties). Cellular products released during myocardial damage (e.g. ATP, adenosine, hydrogen and potassium ions and intracellular alarmins (e.g. HMGB1)) known as Damage Associated Molecular Patterns (DAMPs) serve as the ligands for a sterile inflammatory response to donor heart injury (Ref. 12; incorporated by reference in its entirety). This myocardial inflammation is mediated by master adaptor protein MyD88 of the innate immune system which transduces signals from all toll-like receptors (TLRs) with the exception of TLR3 which signals through TRIF and TLR4 which signals through both MyD88 and TRIF (Refs. 13-14; incorporated by reference in their entireties). Indeed, it is recognized that proinflammatory cytokines (e.g. IL-1β, IL-18, TNFα) contribute to PGD likely from its negative inotropic activity (Ref. 15; incorporated by reference in its entirety). Despite recent use of clinical ex-vivo human heart perfusion platforms which have limited the cold ischemia time, donor hearts are still exposed to warm ischemia during procurement and subsequent implantation in the operative field. In a recent clinical trial of an ex-vivo cardiac perfusion system, severe left ventricular (LV) or right ventricular (RV) primary graft dysfunction remained high at 10.7% despite normothermic cardiac perfusion during organ transport to the recipient hospital (Ref. 16; incorporated by reference in its entirety). Therefore, therapeutic strategies that inhibit immune responses and promote cellular survival can have both early benefits such as lowering the incidence of PGD as well as longer term effects in decreasing immune rejection events.

Furthermore, longer ischemic times enhances innate immune responses and subsequent rejection events. This can be explained by the link between innate immunity is and adaptive immune responses. There are multiple mechanisms by which innate immune signaling enhances adaptive immune responses by alloreactive immune cells (e.g. T and B cells). These include maturation induction in dendritic cells (DCs) by upregulation of surface MHC class II for antigen presentation, increased expression of T cell costimulatory molecules, and increased expression of specific chemokine receptors in “mature” DCs to facilitate trafficking to secondary lymphoid organs to become potent stimulators of T cells. Without innate immune activation, DCs remain in an immature state with low expression of costimulatory molecules so engagement with antigen-specific T cells leads to anergy or apoptosis resulting in tolerance of the transplanted organ (Ref. 17; incorporated by reference in its entirety). Thus, attenuation of acute rejection as well as chronic rejection (i.e. chronic allograft vasculopathy) by immune inhibition may increase the survival of donor hearts beyond the current 10-15 year time frame.

### SUMMARY

Provided herein are organ preservation solutions and methods of use thereof for preserving organs. In particular, provided herein are preservation solutions comprising a mineralocorticoid receptor antagonist, aldehyde dehydrogenase agonist, and/or histone deacetylase inhibitor, and methods of perfusing and storing an organ while awaiting transplantation or non-transplant surgery.

In some embodiments, provided herein are preservation fluids comprising a solution of: (a) a mineralocorticoid receptor antagonist, aldehyde dehydrogenase agonist, and/or histone deacetylase inhibitor; (b) water; (c) buffer; (d) physiologically-relevant concentrations of cations and anions; and having an osmolaroty of 250-500 mOsm/L. In some embodiments, the mineralocorticoid receptor antagonist, aldehyde dehydrogenase agonist, and/or histone deacetylase inhibitor is present at a concentration of 1-100 mM. In some embodiments, the mineralocorticoid receptor antagonist, aldehyde dehydrogenase agonist, and/or histone deacetylase inhibitor is present at a concentration of 5-50 mM. In some embodiments, the mineralocorticoid receptor antagonist, aldehyde dehydrogenase agonist, and/or histone deacetylase inhibitor is present at a concentration of 10-30 mM. In some embodiments, the mineralocorticoid receptor antagonist, aldehyde dehydrogenase agonist, and/or histone deacetylase inhibitor is present at a concentration of 15-25 mM. In some embodiments, the preservation fluid comprises a mineralocorticoid receptor antagonist. In some embodiments, the mineralocorticoid receptor antagonist is selected from spironolactone, eplerenone, canrenoic acid, canrenone, and drospirenone. In some embodiments, the preservation fluid comprises an aldehyde dehydrogenase agonist. In some embodiments, the aldehyde dehydrogenase agonist is selected from Alda-1, Alda-89, Alda-52, Alda-59, Alda-72, Alda-71, Alda-53, Alda-54, Alda-61, Alda-60, Alda-66, Alda-65, Alda-64, and Alda-84. In some embodiments, the preservation fluid comprises a histone deacetylase inhibitor. In some embodiments, the histone deacetylase inhibitor is selected from a hydroxamic acid, depsipeptide, benzamide; electrophilic ketone, phenylbutyrate and valproic acid, nicotinamide, and NA derivatives.

In some embodiments, provided herein are preservation fluids comprising a solution of: (a) valproic acid or a VPA derivative; (b) water; (c) buffer; (d) physiologically-relevant concentrations of cations and anions; and having an osmolaroty of 250-500 mOsm/L (e.g., 250 mOsm/L, 275 mOsm/L, 300 mOsm/L, 325 mOsm/L, 350 mOsm/L, 375 mOsm/L, 400 mOsm/L, 425 mOsm/L, 450 mOsm/L, 475 mOsm/L, 500 mOsm/L, or ranges therebetween). In some embodiments, the valproic acid or derivative thereof is present at a concentration of 10-30 mM, 15-25 mM, 5-50 mM, or 1-100 mM (e.g., 1 mM, 2 mM, 5 mM, 10 mM, 15 mM, 20 mM, 25 mM, 30 mM, 35 mM, 40 mM, 45 mM, 50 mM, 60 mM, 70 mM, 80 mM, 90 mM, 100 mM, or rangers therebetween).

In some embodiments, the cations and anions are selected from potassium, calcium, magnesium, chloride, bicarbinate, hydroxide, and sulfate ions. In some embodiments, the cations and anions are independently present at 0.01 to 200 mM (e.g., 0.01 mM, 0.02 mM, 0.05 mM, 0.1 mM, 0.2 mM, 0.5 mM, 1.0 mM, 2.0 mM, 5.0 mM, 10 mM, 20 mM, 50 mM, 100 mM, 200 mM, or ranges therebetween). In some embodiments, a preservation fluid further comprises one or more impermeants, antioxidants, and/or other components. In some embodiments, one or more impermeants are selected from lucose, LactoB, raffinose, mannitol, dextran, and albumin. In some embodiments, a preservation comprises one or more antioxidants selected from allopurinol (AlloP), glutathione (GSH), tryptophan (Trp), and mannitol. In some embodiments, a preservation fluid comprises components selected from α-ketoglutarate, dextran, blood, heparin, glucose, adenosine, and an amiloride-containing compound. In some embodiments, a preservation fluid comprises a buffer selected from phosphate, bicarbinate, and histidine buffers.

In some embodiments, a preservation fluid comprises a mineralocorticoid receptor antagonist (e.g., spironolactone), aldehyde dehydrogenase agonist (e.g., Alda-1), and/or histone deacetylase inhibitor (e.g., VPA); sodium and potassium cations, chloride anions, glucose, phosphate and bicarbonate buffers, and an osmolatity of between 300 and 450 mOsm/L.

In some embodiments, a preservation fluid comprises v a mineralocorticoid receptor antagonist (e.g., spironolactone), aldehyde dehydrogenase agonist (e.g., Alda-1), and/or histone deacetylase inhibitor (e.g., VPA); sodium, potassium and magnesium cations, chloride anions, phosphate buffer, lactobionate, raffinose, hydroxyethyl starch, allopurinol, glutathione, and an osmolatity of between 250 and 400 mOsm/L.

In some embodiments, a preservation fluid comprises a mineralocorticoid receptor antagonist (e.g., spironolactone), aldehyde dehydrogenase agonist (e.g., Alda-1), and/or histone deacetylase inhibitor (e.g., VPA); sodium, potassium, calcium and magnesium cations, chloride anions, histidine buffer, tryptophan, mannitol, α-ketoglutarate, and an osmolatity of between 250 and 400 mOsm/L.

In some embodiments, a preservation fluid comprises a mineralocorticoid receptor antagonist (e.g., spironolactone), aldehyde dehydrogenase agonist (e.g., Alda-1), and/or histone deacetylase inhibitor (e.g., VPA); sodium and potassium cations, histidine buffer, lactobionate, mannitol, glutathione, and an osmolatity of between 250 and 400 mOsm/L.

In some embodiments, a preservation fluid comprises a mineralocorticoid receptor antagonist (e.g., spironolactone), aldehyde dehydrogenase agonist (e.g., Alda-1), and/or histone deacetylase inhibitor (e.g., VPA); sodium, potassium, calcium and magnesium cations, chloride anions, phosphate buffer, dextran, sulfate, and an osmolatity of between 200 and 400 mOsm/L.

In some embodiments, a preservation fluid comprises a mineralocorticoid receptor antagonist (e.g., spironolactone), aldehyde dehydrogenase agonist (e.g., Alda-1), and/or histone deacetylase inhibitor (e.g., VPA); sodium and potassium cations, blood, heparin, mannitol, albumin, and an osmolatity of between 400 and 500 mOsm/L.

In some embodiments, a preservation fluid comprises a mineralocorticoid receptor antagonist (e.g., spironolactone), aldehyde dehydrogenase agonist (e.g., Alda-1), and/or histone deacetylase inhibitor (e.g., VPA); sodium, potassium, calcium and magnesium cations, chloride anions, bicarbonate buffer, and an osmolatity of between 200 and 400 mOsm/L.

In some embodiments, provided herein are methods of preserving an organ or tissue comprising exposing the organ or tissue to a preservation fluid described herein. In some embodiments, provided herein are methods of preserving an organ or tissue comprising exposing the organ to a preservation fluid comprising a mineralocorticoid receptor antagonist (e.g., spironolactone), aldehyde dehydrogenase agonist (e.g., Alda-1), and/or histone deacetylase inhibitor (e.g., VPA). In some embodiments, the a mineralocorticoid receptor antagonist (e.g., spironolactone), aldehyde dehydrogenase agonist (e.g., Alda-1), and/or histone deacetylase inhibitor (e.g., VPA) is present at a concentration of 15-25 mM, 10-30 mM, 5-50 mM, or 1-100 mM (e.g., 1 mM, 2 mM, 5 mM, 10 mM, 15 mM, 20 mM, 25 mM, 30 mM, 35 mM, 40 mM, 45 mM, 50 mM, 60 mM, 70 mM, 80 mM, 90 mM, 100 mM, or rangers therebetween) in the preservation fluid. In some embodiments, the preservation fluid further comprises one or more of physiologically-relevant concentrations of cations and anions, impermeants, antioxidants, buffer, and other components selected from α-ketoglutarate, dextran, blood, heparin, glucose, adenosine, and an amiloride-containing compound. In some embodiments, the preservation fluid comprises a mineralocorticoid receptor antagonist. In some embodiments, the mineralocorticoid receptor antagonist is selected from spironolactone, eplerenone, canrenoic acid, canrenone, and drospirenone. In some embodiments, the preservation fluid comprises an aldehyde dehydrogenase agonist. In some embodiments, the aldehyde dehydrogenase agonist is selected from Alda-1, Alda-89, Alda-52, Alda-59, Alda-72, Alda-71, Alda-53, Alda-54, Alda-61, Alda-60, Alda-66, Alda-65, Alda-64, and Alda-84. In some embodiments, the preservation fluid comprises a histone deacetylase inhibitor. In some embodiments, the histone deacetylase inhibitor is selected from a hydroxamic acid, depsipeptide, benzamide; electrophilic ketone, phenylbutyrate and valproic acid, nicotinamide, and NA derivatives.

In some embodiments, methods comprise exposing the organ or tissue to a preservation fluid coating the organ or tissue with the preservation fluid. In some embodiments, methods comprise exposing the organ or tissue to a preservation fluid submerging the organ or tissue with the preservation fluid. In some embodiments, methods comprise exposing the organ or tissue to a preservation fluid perfusing the organ or tissue with the preservation fluid. In some embodiments, methods further comprise storing the organ at a temperature between −20° C. and 20° C. (e.g., −20° C., −18° C., −16° C. −14° C. −12° C., −10° C., −8° C., −6° C. −4° C., −2° C., 0° C., 2° C., 4° C., 6° C., 8° C., 10° C., 12° C., 14° C., 16° C., 18° C., 20° C., or ranges therebetween). In some embodiments, the organ is selected from a heart, kidneys, liver, lungs, pancreas, intestine, and thymus. In some embodiments, the tissue is selected from bones, tendons, cornea, skin, heart valves, nerves and veins. In some embodiments, methods further comprise removing the organ or tissue from a donor. In some embodiments, the organ or tissue is exposed to the preservation fluid after being removed from the donor.

In some embodiments, the organ is a heart. In some embodiments, methods further comprise arresting the heart with a cardioplegic solution prior to removal from the donor.

In some embodiments, methods further comprise transplanting the organ or tissue into a recipient. In some embodiments, methods further comprise exposing (e.g., coating, submerging, perfusing, etc.) the organ or tissue in blood (e.g., recipient's blood, transfused blood, etc.) prior to transplanting.

### BRIEF DESCRIPTION OF THE DRAWINGS

FIG. 1. Coronary vascular resistance after two hours of ex-vivo pig heart perfusion. Addition of VPA to preservation solution improved coronary artery resistance compared with control with 3 pig hearts in each group.

FIG. 2. Rate of successful reanimation of donor hearts with VPA treatment. None of the hearts reanimated at 7 and 9 hours when treated with HTK solution alone. In comparison, VPA-treated hearts reanimated 100% of the time after 7 hours of preservation (P=0.003) and 60% of the time after 9 hours of storage (P=0.058).

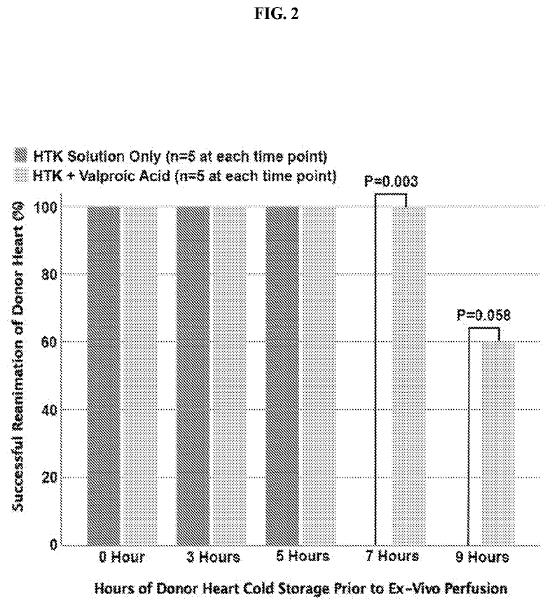

FIG. 3. The hemodynamic of perfused heart after different period of cold storage in HTK storage solution of HTK and spironolactone. The max dp/dt and −min dp/dt were calculated by averaging the max/min dp/dt in 20 minutes stable period after different cold storage periods followed by perfusion. The max dp/dt or −min dp/dt of hearts were normalized to percentage of time 0. Blue circle: HTK only; Red square: HTK+50 μM Spironolactone. **p<0.01, ***p<0.001,****p<0.0001.

FIG. 4. The hemodynamic of perfused heart after different period of cold storage in HTK storage solution of HTK and Alda-1. The max dp/dt and min dp/dt were calculated by averaging the max/min dp/dt in 20 minutes stable period after different cold storage periods followed by perfusion. The max dp/dt or −min dp/dt of hearts were normalized to percentage of time 0. Blue circle: HTK only; Red square: HTK+20 μM Alda-1. * p<0.05, **p<0.01.

FIG. 5A-C. VPA improves donor heart function after prolonged storage and ex-vivo reperfusion. The max dp/dt (A) and min dp/dt (B) were calculated by averaging the max/min dp/dt in 20 minutes stable period after different cold storage periods followed by perfusion. The max dp/dt or −min dp/dt of hearts were normalized to percentage of time 0. **p<0.01. (C) VPA suppress the Ill and Myd88 protein level induced by cold storage.

FIG. 6A-D. Prolonged cold storage of donor heart reduced heart function after reperfusion ex vivo. (A) max dp/dt (contraction) and (B) min dp/dt (relaxation) were calculated by average the max/min dp/dt over a 20 minutes period after different cold storage periods followed by 90 minutes of reperfusion. ** P<0.01, *** P<0.001. N=4 at each time point. (C) TUNEL staining of hearts after perfusion with 0 hour (h) and 8 h storage period. Bar chart shows the TUNEL positive cells per high powered field at each time point (n=4). (D) Donor hearts have increased cleaved poly (ADP-ribose) polymerase (PARP) level after 8 h storage compared to Oh consistent with increased cell death.

FIG. 7A-E. Cold storage activates inflammatory response and MR signaling in donor heart. GSEA shows that gene sets related (A) inflammatory response, (B) epithelial mesenchymal transition, a critical process of fibrosis, and (C) downregulated genes in MR KO mice are enriched in hearts after 4 h and 8 h of storage followed by reperfusion compared to 0 h. (E) Expression of genes at 0 h, 4 h and 8 h at donor heart after 90 mins of reperfusion. Each gene has adjust p<0.05 for time series analysis.

FIG. 8. Double staining of MR and CD31 or cTnT in donor heart after 0 h, 4 h and 8 h of storage followed by 90 minutes perfusion. MR expression is detected in both endothelial cells (CD31) and cardiomyocytes (cTnT). After prolonged cold storage, the number of double positive staining of CD31/MR and cTnT/MR increased. Arrow: nuclear localization of MR. Scale bar: 25 μm.

FIG. 9A-C. Spironolactone inhibits MR signals and improves donor heart function after prolonged storage and ex-vivo reperfusion. Following spironolactone treatment, much improved (A) max dp/dt and (B) min dp/dt after prolonged storage after 8 hours and 12 hours was observed compared to HTK alone. N=4. **p<0.01, ***p<0.001 (C) Spironolactone suppress the Il1 and Myd88 protein level induced by cold storage.

FIG. 10A-B. Canrenone administration improves donor heart function after prolonged storage and ex-vivo reperfusion. Following spironolactone treatment, much improved (A) max dp/dt and (B) min dp/dt after prolonged storage after 4 hours and 8 hours is see compared to HTK alone. N=4. **p<0.01, ***p<0.001.

FIG. 11A-B. Alda-1 administration improves donor heart function after prolonged storage and ex-vivo reperfusion. Following Alda-ltreatment, improved (A) max dp/dt and (B) min dp/dt after prolonged storage after 8 hours were observed compared to HTK alone. N=3. *p<0.05, **p<0.01.

### DETAILED DESCRIPTION

Provided herein are organ preservation solutions and methods of use thereof for preserving organs. In particular, provided herein are preservation solutions comprising a mineralocorticoid receptor antagonist, aldehyde dehydrogenase agonist, and/or histone deacetylase inhibitor, and methods of perfusing and storing an organ while awaiting transplantation or non-transplant surgery.

In some embodiments, provided herein are organ preservation solutions comprising a mineralocorticoid receptor antagonist. Mineralocorticoid receptor antagonists bind to and block the activation of mineralocorticoid receptors by mineralocorticoids such as aldosterone. Examples of mineralocorticoid receptor antagonists that find use in embodiments herein include spironolactone (an aldosterone receptor antagonist used for the treatment of hypertension, hyperaldosteronism, edema due to various conditions, hirsutism (off-label) and hypokalemia), active spironolactone metabolites (e.g., canrenone, etc.), eplerenone (an aldosterone receptor antagonist used to improve survival of patients with symptomatic heart failure and to reduce blood pressure), canrenoic acid (metabolized to canrenone in the body), canrenone, and drospirenone (a progestin used in oral contraceptive pills for the prevention of pregnancy and other conditions).

In some embodiments, provided herein are organ preservation solutions comprising an aldehyde dehydrogenases agonist. Aldehyde dehydrogenases (ALDHs) are a family of detoxifying enzymes. The human genome has 19 known ALDH genes, but one ALDH, ALDH2, emerges as a particularly important enzyme in a variety of human pathologies. Aldehyde dehydrogenase activators (Aldas) are a family of small molecule activators of ALDHs, exemplified by lda-1 [N-(1,3-benzodioxo1-5-ylmethyl)-2,6-dichlorobenzamide, MW 324 ]. Alda-1 is an allosteric agonist of ALDH2, and corrects a structural defect in the ALDH2*2 mutant present in 8% of the human population. Alda-89 [5-(2-propenyl)-1,3-benzodioxole, commonly known as safrole, MW=162] is a selective activator of acetaldehyde metabolism by ALDH3A1. Other Aldas that find use in embodiments herein include Alda-52 (1-methoxy-naphthalene-2-carboxylic acid (benzo[1,3]dioxo1-5-ylmethyl)-amide), Alda-59 (4-[(benzo[1,3]dioxo1-5-ylmethyl)-sulfamoyl]-thiophene-2-carboxylic acid amide), Alda-72 (N-benzo[1,3]dioxo1-5-ylmethyl-2-(1-oxo-1,2-dihydro-2,3,9-triaza-fluoren-9-yl)-acetamide), Alda-71 (N-(4-methyl-benzyl)-2-(1-oxo-1,2-dihydro-2,3,9-triaza-fluoren-9-yl)-acetamide), Alda-53 (N-benzo[1,3]dioxo1-5-ylmethyl-2-chloro-5-[1,2,4]triazol-4-yl-benzamide), Alda-54 (1-ethyl-4-oxo-1,4-dihydro-chromeno[3,4-d]imidazole-8-sulfonic acid (benzo[1,3]dioxo1-5-ylmethyl)-amide), Alda-61 (5-(3,4-dimethyl-isoxazol-5-yl)-2-methyl-N-(4-methyl-benzyl)-benzene sulfonamide), Alda-60 (2-methyl-N-(4-methyl-benzyl)-5-(3-methyl-isoxazol-5-yl)-benzene sulfonamide), Compound Alda-66 (2-(2-isopropyl-3-oxo-2,3-dihydro-imidazo[1,2-c]quinazolin-5-ylsulfanyl)-N-(4-methyl-benzyl)-propionamide), Alda-65 (N-(3,5-dimethyl-phenyl)-2-(2-isopropyl-3-oxo-2,3-dihydro-imidazo[1,2-c]quinazolin-5-ylsulfanyl)-acetamide), Alda-64 (2-(azepane-1-carbonyl)-N-(2-chloro- benzyl)-2,3-dihydro-benzo[1,4]dioxine-6-sulfonamide), Alda-84 (N-(2-hydroxy-phenyl)-3-phenyl-acrylamide), and any other suitable Aldas known in the field, for example, those described in U.S. Pub. No. 2010/0113423; incorporated by reference in its entirety.

In some embodiments, provided herein are organ preservation solutions comprising a histone deacetylase inhibitor. Histone deacetylase inhibitors (HDAC inhibitors, HDACi, HDIs) are chemical compounds that inhibit histone deacetylases. HDIs have a long history of use in psychiatry and neurology as mood stabilizers and anti-epileptics. More recently they are being investigated as possible treatments for cancers, parasitic, and inflammatory diseases. Based on their homology of accessory domains to yeast histone deacetylases, the 18 currently known human histone deacetylases are classified into four groups (I-IV): Class I, which includes HDAC1, -2, -3 and -8 are related to yeast RPD3 gene; Class HA, which includes HDAC4, -5, -7 and -9; Class IIB -6, and -10 are related to yeast Hdal gene; Class III, also known as the sirtuins are related to the Sir2 gene and include SIRT1-7; Class IV, which contains only HDAC11 has features of both Class I and II. In some embodiments, a histone deacetylase inhibitor that finds use herein is selective for one or more classes of HDAC (e.g., Class I, Class IIA, Class III, and/or Class IV). In some embodiments, a histone deacetylase inhibitor that finds use herein is a general HDAC inhibitor. The “classical” HDIs act exclusively on Class I, II and Class IV HDACs by binding to the zinc-containing catalytic domain of the HDACs. These classical HDIs are classified into several groupings named according to the chemical moiety that binds to the zinc ion (except cyclic tetrapeptides which bind to the zinc ion with a thiol group). Some examples in decreasing order of the typical zinc binding affinity include: hydroxamic acids (or hydroxamates), such as trichostatin A; cyclic tetrapeptides (such as trapoxin B), and the depsipeptides; benzamides; electrophilic ketones; and aliphatic acid compounds such as phenylbutyrate and valproic acid. “Second-generation” HDIs include the hydroxamic acids vorinostat (SAHA), belinostat (PXD101), LAQ824, and panobinostat (LBH589); and the benzamides entinostat (MS-275), tacedinaline (CI994), and mocetinostat (MGCD0103). The sirtuin Class III HDACs are dependent on NAD+ and are, therefore, inhibited by nicotinamide, as well as derivatives of NAD, dihydrocoumarin, naphthopyranone, and 2-hydroxynaphthaldehydes. Any of the above HDIs may find use in embodiments herein.

Valproic acid (VPA) is a histone deacetylase inhibitor with potent anti-inflammatory effects. Inhibition of HDAC leads to epigenetic modifications that cause relaxation of the nucleosome structure allowing the transcription of many gene targets (Ref. 18; incorporated by reference in its entirety). VPA attenuates ischemia and reperfusion (I/R) injury in various organ systems such as the lungs (Ref. 19; incorporated by reference in its entirety), kidneys (Ref. 20; incorporated by reference in its entirety), and brain (Refs 21-22; incorporated by reference in their entireties). Myocardial protection in I/R has not been well described in the literature. Following myocardial infarction, VPA was able to reduce myocyte hypertrophy and collagen deposition in both the remote and border zones of the infarcted left ventricle with preservation of systolic function (Ref. 23; incorporated by reference in its entirety). VPA also reduced inflammation and injury in hemorrhage related pulmonary inflammation (Ref. 24; incorporated by reference in its entirety), septic and hemorrhagic shock (Ref. 25; incorporated by reference in its entirety), and pulmonary hypertension due to hypoxemia (Refs. 26-27; incorporated by reference in their entireties). In these scenarios of ischemic injury, VPA was able to inhibit the expression of IL-1β, IL-4, IL-6, IL-17, IFN-γ, TNF-α, as well as reduce leukocyte infiltration into the target tissue (Refs. 27-30; incorporated by reference in their entireties). VPA was also demonstrated to modulate the adaptive immune system in graft versus host disease following bone marrow transplantation by downregulating Th1 and Th17 cells to decrease the severity of disease (Ref. 31; incorporated by reference in its entirety).

A variety of valproic acid derivatives are well known in the field. Experiments have demonstrated that valproic acid derivatives, such as valnoctamide (VCD) and c-Butyl-propyl-acetamide (SPD), exhibit similar biological characteristics to VPA (Neuman et al. Clinical Biochemistry 46 (2013) 1532-1537; incorporated by reference in its entirety). In some embodiments herein, a valproic acid derivative is employed in place of VPA. In some embodiments, provided herein are compositions (e.g., preservation fluids), kits, and methods comprising a suitable VPA derivative. In some embodiments, any embodiments described herein comprising VPA may also be employed or provided with a suitable VPA derivative. Exemplary VPA derivatives include VCD, SPD, and the VPA derivatives depicted in Table 3.

TABLE 3
Exemplary Valproic Acid Derivatives.

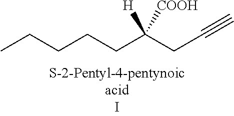

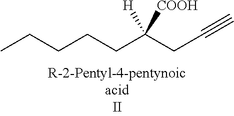

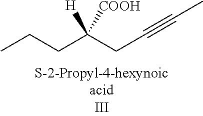

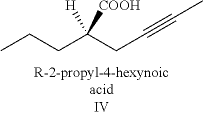

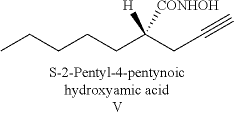

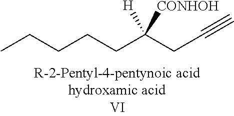

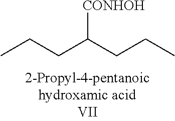

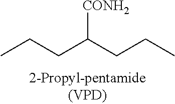

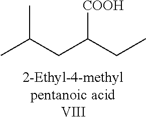

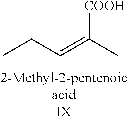

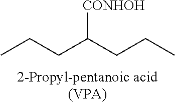

In some embodiments, a suitable VPA derivative comprises a 6-8 member alkyl chain. In some embodiments, the alkyl chain comprises one or more double or triple bonds. In some embodiments, the alkyl chain comprises (CH₂)₆, (CH₂)₇, or CH₂)₈. In some embodiments, the VPA derivative comprises a substituent at the 4 or 5 position of the alkyl chain. In some embodiments, the alkyl chain comprises a substituent at one or more additional positions.

In some embodiments, a valproic acid derivatives are branched carboxylic acids as described by Formula 1:

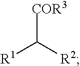

wherein R¹ and R² independently are saturated or unsaturated aliphatic C₂₋₅, which optionally comprises one or several heteroatoms and which may be substituted, R³ is hydroxyl, halogen, alkoxy or an optionally alkylated amino group. Different R¹ and R² residues give rise to chiral compounds. The present invention encompasses the racemic mixtures of the respective compounds. The hydrocarbon chains R¹ and R² may comprise one or several heteroatoms (e.g. O, N, S) replacing carbon atoms in the hydrocarbon chain. This is due to the fact that structures very similar to that of carbon groups may be adopted by heteroatom groups when the heteroatoms have the same type of hybridization as a corresponding carbon group. R¹ and R² may be substituted. Possible substituents include hydroxyl, amino, carboxylic and alkoxy groups as well as aryl and heterocyclic groups. In some embodiments, “COR³” is a carboxylic group. In other embodiments, R³ is a halides (e.g., chloride, bromide, etc.), ester, alkoxy, etc. According to the present invention also pharmaceutically acceptable salts of a compound of formula I can be used.

Other VPA derivatives understood in the field are also within the scope herein.

Experiments conducted during development of embodiments herein demonstrate that VPA treatment leads to preservation of organ (e.g., myocardia)1 function and greatly attenuates inflammation. These findings indicate that pre-transplant treatment of organs such as the heart, lungs, liver, kidney, pancreas, and musculoskeletal structure with a preservation fluid comprising VPA improved post-transplant organ function, decreasing rejection and prolonging graft and patient survival.

In some embodiments, provided herein is an organ/tissue preservation fluid comprising a mineralocorticoid receptor antagonist, aldehyde dehydrogenase agonist, and/or histone deacetylase inhibitor. In some embodiments, a mineralocorticoid receptor antagonist, aldehyde dehydrogenase agonist, and/or histone deacetylase inhibitor is provided as an additional component of an existing storage or preservation solution. In some embodiments, provided herein is an organ/tissue preservation fluid comprising valproic acid (VPA) or a derivative thereof. In some embodiments, valproic acid or a VPA derivative is provided as an additional component of an existing storage or preservation solution. Various storage or preservation media may be employed, including but not limited to HTK solution, Celsior solution, Perfadex solution, Perfadex Plus solution, Euro-Collins solution, modified Euro-collins solution, Optisol-GS, K-Sol, McCarey-Kaufman (M-K) solution, Roswell Park Memorial Institute-1,640 solution (RPMI), University of Wisconsin solution and variations thereof.

Euro Collins (EC) solution was designed in the 1960s and considered the preservation solution of choice for over 15 years until organ perseveration was revolutionized by the introduction of University of Wisconsin (UW) solution in 1988 (Mühlbacher et al. Transplant Proc1999;31:2069-70; incorporated by reference in its entirety). However, the high molecular weight compounds within UW such as hydroxyethyl starch (HES) resulted in a highly viscous solution that was implicated in part, to organ dysfunction thereby, supporting the development of less vicious alternatives including Celsior (CEL) and histidine-tryptophan-ketoglutarate (HTK) (Feng et al. Hepatobiliary Pancreat Dis Int 2006;5:490-4; incorporated by reference in its entirety). Many targeted approaches to cardiac organ preservation have been attempted including Plegisol which arose from the initial St. Thomas solution used for cardioplegia, albeit with slight modifications including the addition of a buffering system (Chambers et al. Eur J Cardiothorac Surg 1989;3:346-52; incorporated by reference in its entirety). In contrast to the aforementioned acellular approaches, Papworth solution was centered on the inclusion of donor blood in its composition (Divisi et al. Eur J Cardiothorac Surg 2001;19:333-8; incorporated by reference in its entirety).

In some embodiments, appropriate storage or preservation media (for use in conjunction with a mineralocorticoid receptor antagonist (e.g., spironolactone), active spironolactone metabolites (e.g., canrenone, etc.),aldehyde dehydrogenase agonist (e.g., Alda-1), and/or histone deacetylase inhibitor (e.g., VPA)) is selected based on criteria understood by a clinician or transplant technology specialist. In some embodiments, appropriate storage or preservation media (for use in conjunction with a mineralocorticoid receptor antagonist (e.g., spironolactone, active spironolactone metabolites (e.g., canrenone, etc.), etc.), aldehyde dehydrogenase agonist (e.g., Alda-1), and/or histone deacetylase inhibitor (e.g., VPA)) is selected based the type of organ or tissue to be transplanted. For example, Optisol-GS, K-Sol, and McCarey-Kaufman (M-K) solution are understood for use in corneal transplant; therefore, in certain embodiments herein, a preservation fluid is provided comprising (1) a mineralocorticoid receptor antagonist (e.g., spironolactone, canrenone, etc.), aldehyde dehydrogenase agonist (e.g., Alda-1), and/or histone deacetylase inhibitor (e.g., VPA)) and (2) Optisol-GS, K-Sol, or McCarey-Kaufman (M-K) solution (for use in preserving, storing, and/or transplanting cornea). RPMI finds use in skin preservation; as such, in some embodiments, a preservation fluid is provided comprising (1) a mineralocorticoid receptor antagonist (e.g., spironolactone, canrenone, etc.), aldehyde dehydrogenase agonist (e.g., Alda-1), and/or histone deacetylase inhibitor (e.g., VPA)) and (2) RPMI (for use in preserving, storing, and/or transplanting skin). DK solution, Celsior solution, Perfadex solution, Perfadex Plus solution, Euro-Collins solution, modified Euro-collins solution, and UW solution are understood for use in pulmonary and heart transplant; therefore, in certain embodiments herein, a preservation fluid is provided comprising (1) a mineralocorticoid receptor antagonist (e.g., spironolactone, canrenone, etc.), aldehyde dehydrogenase agonist (e.g., Alda-1), and/or histone deacetylase inhibitor (e.g., VPA)) and (2) DK solution, Celsior solution, Perfadex solution, Perfadex Plus solution, Euro-Collins solution, modified Euro-collins solution, or UW solution (for use in preserving, storing, and/or transplanting heart and/or lungs). In some embodiments, (1) a mineralocorticoid receptor antagonist (e.g., spironolactone, canrenone, etc.), aldehyde dehydrogenase agonist (e.g., Alda-1), and/or histone deacetylase inhibitor (e.g., VPA)) and (2) one or more of the preservation solutions described herein find use in the transplant of a tissue or organ that is not traditionally associated with that preservation solution. In some embodiments, (1) a mineralocorticoid receptor antagonist (e.g., spironolactone, canrenone, etc.), aldehyde dehydrogenase agonist (e.g., Alda-1), and/or histone deacetylase inhibitor (e.g., VPA)) and (2) one or more of the preservation solutions described herein find use in the transplant of liver, kidney, etc.

In some embodiments, preservation solutions herein comprise a mineralocorticoid receptor antagonist (e.g., spironolactone, canrenone, etc.), aldehyde dehydrogenase agonist (e.g., Alda-1), and/or histone deacetylase inhibitor (e.g., VPA)) and the components of one or more of HTK solution, Celsior solution, Perfadex solution, Perfadex Plus solution, Euro-Collins solution, modified Euro-collins solution, Optisol-GS, K-Sol, McCarey-Kaufman (M-K) solution, Roswell Park Memorial Institute-1,640 solution (RPMI), University of Wisconsin solution and variations thereof. In other embodiments, provided herein are preservation fluids comprising a mineralocorticoid receptor antagonist (e.g., spironolactone, canrenone, etc.), aldehyde dehydrogenase agonist (e.g., Alda-1), and/or histone deacetylase inhibitor (e.g., VPA)) and one or more additional components, for example, selected from the components described herein. In some embodiments, provided herein are preservation fluids comprising a mineralocorticoid receptor antagonist (e.g., spironolactone, canrenone, etc.), aldehyde dehydrogenase agonist (e.g., Alda-1), and/or histone deacetylase inhibitor (e.g., VPA)) and one or more components from one or more of the preservation solutions described herein.

In some embodiments, preservation solutions contain a mineralocorticoid receptor antagonist (e.g., spironolactone, canrenone, etc.), aldehyde dehydrogenase agonist (e.g., Alda-1), and/or histone deacetylase inhibitor (e.g., VPA)) in addition to one or more of monovalent cations (e.g., Na⁺, K⁺, etc.), an impermeant/colloid (e.g., glucose, LactoB, raffinose, mannitol, dextran, albumin, etc.), buffer (e.g., phosphate buffer, bicarbinate, histidine, etc.), antioxidnats (e.g., allopurinol (AlloP), glutathione (GSH), tryptophan (Trp), mannitol, etc.), divalent cations (e.g., Ca²⁺, Mg²⁺, etc.), anions (e.g., Cl⁻, OH⁻, SO₄²⁻, etc.), glucose, heparin, dextran, alpha ketoglutarate, etc.

In some embodiments, preservation fluids comprise one or more amino acids (e.g., L-amino acids, D-amino acids, a racemic mixture, standard amino acids, modified amino acids, etc.), an energy source (e.g., adenosine triphosphate (ATP), co-enzyme A, pyruvate, flavin adenine dinucleotide (FAD), thiamine pyrophosphate chloride (co-carboxylase), β-nicotinamide adenine dinucleotide (NAD), β-nicotinamide adenine dinucleotide phosphate (NADPH), nucleosides, nucleotides, phosphate derivatives of nucleosides, etc.), a stimulant (e.g., catecholamines (e.g., epinephrine and/or norepinephrine), vasopressin, Anthropleurin-A and Anthropleurin-B, β1/β2-adrenoreceptor blocking agents, buplinarol, pindolol, alprenolol, cardiac glycosides, etc.), etc.

In certain embodiments, preservation fluids comprise one or more buffers or buffering components. For example, suitable buffer systems include 2-morpholinoethanesulfonic acid monohydrate (MES), cacodylic acid, H₂CO₃/3, citric acid, bis(2-hydroxyethyl)-imino-tris-(hydroxymethyl)-methane (Bis-Tris), N-carbamoylmethylimidino acetic acid (ADA), 3-bis[tris(hydroxymethyl)methylamino]propane (Bis-Tris Propane), piperazine-1,4-bis(2-ethanesulfonic acid) (PIPES), N-(2-Acetamido)-2-aminoethanesulfonic acid (ACES), imidazole, N,N-bis(2-hydroxyethyl)-2-aminoethanesulfonic acid (BES), 3-(N-morpholino)propanesulphonic acid (MOPS), NaH₂PO₄/Na₂HPO₄, N-tris(hydroxymethyl)methyl-2-aminoethanesulfonic acid (TES), N-(2-hydroxyethyl)-piperazine-N′-2-ethanesulfonic acid (HEPES), N-(2-hydroxyethyl)piperazine-N′-(2-hydroxypropanesulfonic acid) (HEPPSO), triethanolamine, N-[tris(hydroxymethyl)methyl]glycine (Tricine), tris hydroxymethylaminoethane (Tris), glycineamide, N,N-bis(2-hydroxyethyl)glycine (Bicine), glycylglycine, N-tris(hydroxymethyl)methyl-3-aminopropanesulfonic acid (TAPS), or a combination thereof. In some embodiments, preservation fluids contain sodium bicarbonate, potassium phosphate, or TRIS buffer.

Preservation fluids may include other components, for example, to help maintain the organ and/or protect it against ischemia, reperfusion injury and other ill effects during perfusion. In certain exemplary embodiments these components may include hormones (e.g., insulin), vitamins, and/or steroids (e.g., dexamethasone and SOLUMEDROL).

In certain embodiments, a blood product is provided with the preservation fluids (e.g., as a component of the preservation fluid, separate from the preservation fluid, etc.). Exemplary suitable blood products may include whole blood, and/or one or more components thereof such as blood serum, plasma, albumin, and red blood cells. In embodiments where whole blood is used, the blood may be passed through a leukocyte and platelet depleting filter to reduce pyrogens, antibodies and/or other items that may cause inflammation in the organ. Thus, in some embodiments, the solution employs whole blood that has been at least partially depleted of leukocytes and/or whole blood that has been at least partially depleted of platelets.

In some embodiments, one or more therapeutics may be included in the preservation fluid, including hormones, such as thyroid hormones (e.g., T₃ and/or T₄ thyroid hormones), anti-arrhythmic drugs, beta blockers, anti fungals, anti-microbials or anti-biotics (e.g., bacitracin, chlorhexidine, chlorhexidine digluconate, ciprofloxacin, clindamycin, erythromycin, gentamicin, lomefloxacin, metronidazole, minocycline, moxifloxacin, mupirocin, neomycin, ofloxacin, polymyxin B, rifampicin, ruflozacin, tetracycline, tobramycin, triclosan, vancomycin, etc.), anti-inflamatories, anti-proliferatives (e.g., 5-FU, taxol, daunorubicin, mitomycin, etc.), anti-virals (e.g., trifluridine, cidofovir, acyclovir, penciclovir, famciclovir, valcyclovir, gancyclovir, docosanol, etc.), retinoids (e.g., retinol, retinal, isotretinoin, acitretin, adapalene, tazarotene, bexarotene, etc.), NSAIDs (e.g., naproxen, suprofen, ketoprofen, ibuprofen, flurbiprofen, diclofenac, indomethacin, celecoxib, rofecoxib, etc.), vitamin D3 and vitamin D3 analogs (e.g., doxercalciferol, seocalcitol, calcipotriene, tacalcitol, calcitriol, ergocalciferol, calcifediol, etc.), calcium channel blockers, complement neutralizers, ACE inhibitors, immuno-suppressants, steroids (e.g., androgenic and estrogenic steroid hormones, androgen receptor antagonists and 5-α-reductase inhibitors, corticosteroids, alclometasone, clobetasol, fluocinolone, fluocortolone, diflucortolone, fluticasone, halcinonide, mometasone, prednisone, prednisolone, methylprednisolone, triamcinolone, betamethasone, dexamethasone, etc.).

In some embodiments, components of a preservation solution (e.g., each individual component) are present in concentrations between 0.1 and 1000 millimoles (mmol) of component per liter (L) of preservation solution (e.g., 0.1 mmol/L, 0.2 mmol/L, 0.3 mmol/L, 0.4 mmol/L, 0.5 mmol/L, 0.6 mmol/L, 0.7 mmol/L, 0.8 mmol/L, 0.9 mmol/L, 1.0 mmol/L, 2.0 mmol/L, 3.0 mmol/L, 4.0 mmol/L, 5.0 mmol/L, 6.0 mmol/L,7.0 mmol/L, 8.0 mmol/L, 9.0 mmol/L, 10 mmol/L, 20 mmol/L, 30 mmol/L, 40 mmol/L, 50 mmol/L, 60 mmol/L,70 mmol/L, 80 mmol/L, 90 mmol/L, 100 mmol/L, 200 mmol/L, 300 mmol/L, 400 mmol/L, 500 mmol/L, 600 mmol/L,700 mmol/L, 800 mmol/L, 900 mmol/L, 1000 mmol/L, or ranges therebetween). Table 2 sets forth exemplary concentrations for certain exemplary components of a preservation solution. Other components may be present in similar concentrations or other concentrations set forth herein.

TABLE 2
Exemplary components and concentrations for preservation fluid

| | Exemplary |
|---|---|
| Component | concentration |
| Alanine | 1 mg/L-10 g/L |
| Arginine | 1 mg/L-10 g/L |
| Asparagine | 1 mg/L-10 g/L |
| Aspartic Acid | 1 mg/L-10 g/L |
| Cysteine | 1 mg/L-10 g/L |
| Cystine | 1 mg/L-10 g/L |
| Glutamic Acid | 1 mg/L-10 g/L |
| Glutamine | 1 mg/L-10 g/L |
| Glycine | 1 mg/L-10 g/L |
| Histidine | 1 mg/L-10 g/L |
| Hydroxyproline | 1 mg/L-10 g/L |
| Isoleucine | 1 mg/L-10 g/L |
| Leucine | 1 mg/L-10 g/L |
| Lysine | 1 mg/L-10 g/L |
| Methionine | 1 mg/L-10 g/L |
| Phenylalanine | 1 mg/L-10 g/L |
| Proline | 1 mg/L-10 g/L |
| Serine | 1 mg/L-10 g/L |
| Threonine | 1 mg/L-10 g/L |
| Tryptophan | 1 mg/L-10 g/L |
| Tyrosine | 1 mg/L-10 g/L |
| Valine | 1 mg/L-10 g/L |
| Adenine | 1 mg/L-10 g/L |
| ATP | 10 ug/L-100 g/L |
| Adenylic Acid | 10 ug/L-100 g/L |
| ADP | 10 ug/L-100 g/L |
| AMP | 10 ug/L-100 g/L |
| Ascorbic Acid | 1 ug/L-10 g/L |
| D-Biotin | 1 ug/L-10 g/L |
| Vitamin D-12 | 1 ug/L-10 g/L |
| Cholesterol | 1 ug/L-10 g/L |
| Dextrose (Glucose) | 1 g/L-150 g/L |
| Multi-vitamin Adult | 1 mg/L-20 mg/L or |
| Epinephrine | 1 ug/L-1 g/L |
| Folic Acid | 1 ug/L-10 g/L |
| Glutathione | 1 ug/L-10 g/L |
| Guanine | 1 ug/L-10 g/L |
| Inositol | 1 g/L-100 g/L |
| Riboflavin | 1 ug/L-10 g/L |
| Ribose | 1 ug/L-10 g/L |
| Thiamine | 1 mg/L-10 g/L |
| Uracil | 1 mg/L-10 g/L |
| Calcium Chloride | 1 mg/L-100 g/L |
| NaHCO₃ | 1 mg/L-100 g/L |
| Magnesium sulfate | 1 mg/L-100 g/L |
| Potassium chloride | 1 mg/L-100 g/L |
| Sodium glycerophosphate | 1 mg/L-100 g/L |
| Sodium Chloride | 1 mg/L-100 g/L |
| Sodium Phosphate | 1 mg/L-100 g/L |
| Insulin | 1 IU-150 IU |
| Serum albumin | 1 g/L-100 g/L |
| Pyruvate | 1 mg/L-100 g/L |
| Coenzyme A | 1 ug/L-10 g/L |
| Serum | 1 ml/L-100 ml/L |
| Heparin | 500 U/L-1500 U/L |
| Solumedrol | 200 mg/L-500 mg/L |
| Dexamethasone | 1 mg/L-1 g/L |
| FAD | 1 ug/L-10 g/L |
| NADO | 1 ug/L-10 g/L |
| adenosine | 1 mg/L-10 g/L |
| guanosine | 1 mg/L-10 g/L |
| GTP | 10 ug/L-100 g/L |
| Component | Solution |
| GDP | 10 ug/L-100 g/L |
| GMP | 10 ug/L-100 g/L |

In some embodiments, a preservation fluid is provided at the proper concentration for administration to a tissue or organ. In other embodiments, a concentrated preservation fluid is provided (e.g., 2×, 3×, 4×, 5×, 6×, 7×, 8×, 9×, 10×, 15×, 20×, 50×, 100×, or more, or ranges therebetween), and the concentrated preservation fluid is diluted to an appropriate concentration for administration prior to use. In some embodiments, a preservation fluid is provided as two or more separate compositions (e.g., fluids, dried reagents, etc.) that are combined (e.g., with mixing) prior to administration. In some embodiments, a preservation fluid is provided as a dried reagent that is dissolved in solution (e.g., water, buffer, etc.) prior to use.

In certain embodiments, a preservation fluid is provided in the form of a kit that includes. An exemplary kit may include components identified above in one or more fluid solutions for use in an organ perfusion. In certain embodiments, the kit may include multiple solutions, such as a preservation fluid, a nutritional solution, a supplemental composition or solution, etc., or may include dry components that may be regenerated in a fluid to form one or more solutions . A kit may also comprise components from the solutions in one or more concentrated solutions which, on dilution, provide a preservation, nutritional, and/or supplemental solution as described herein. The kit may also include a priming solution.

In certain embodiments, the kit is provided in a single package, wherein the kit includes one or more solutions (or components necessary to formulate the one or more solutions by mixing with an appropriate fluid), and instructions for sterilization, flow and temperature control during perfusion and use and other information necessary or appropriate to apply the kit for perfusion. In certain embodiments, a kit is provided with only a single solution and a set of instructions and other information or materials necessary or useful to operate the solution.

In some embodiments, the preservation fluid or kit is provided with devices, instruments, materials (e.g., tubing, syringe, bags, etc.) for administering the fluid to an organ or tissue.

In some embodiments, methods are provided herein for preserving and/or storing an organ/tissue using the preservation fluids described herein. In some embodiments, a preservation fluid is administered to a tissue/organ by a clinician or other medical operator. In some embodiments, the organ/tissue is perfused with the preservation fluid. In some embodiments, a system is provided for perfusing an organ with the preservation fluid. In some embodiments, the system comprises one or more tubes, conduits, channels, etc. for delivering the preservation fluid to the organ/tissue. In some embodiments, the system comprises one or more tubes, conduits, channels, etc. for receiving the preservation fluid from the organ/tissue. In some embodiments, the system comprises a pump, syringe, or other mechanism for generating the flow of the preservation fluid.

In some embodiments, a tissue/organ is removed from the donor, and is subsequently exposed to the preservation fluid (e.g., perfused with). In some embodiments, a tissue/organ is exposed to the preservation fluid (e.g., perfused with) prior to being removed (e.g., fully removed) from the donor.

In some embodiments, preservation fluid is left in the tissue/organ (or vasculature thereof) for transport/storage of the tissue/organ. Following treatment with the preservation fluid, the tissue/organ is stored for a time period before being transplanted into a recipient. In some embodiments, the tissue/organ is transported during the storage time. In some embodiments, a time period of 5 minutes to 6 months (e.g., 5 minutes, 10 minutes, 30 minutes, 1 hour, 2 hours, 4 hours, 6 hours, 12 hours, 24 hours, 2 days, 3 days, 4 days, 7 days, 14 days, 30 days, 2 months, 4 months, 6 months, or more or ranges therebetween) elapses between removing the organ/tissue from the donor and transplanting the organ/tissue into the recipient.

In some embodiments, during storage/transport, the organ is maintained at a specific temperature (e.g., between −20° C. and 20° C. (e.g., −20° C., −18° C., −16° C., −14° C., −12° C., −10° C., −8° C., −6° C., −4° C., −2° C., 0° C., 2° C., 4° C., 6° C., 8° C., 10° C., 12° C., 14° C., 16° C., 18° C., 20° C., or ranges therebetween)).

### EXPERIMENTAL

### Example 1

### Organ Protection by Histone Deacetylase Inhibitor (VPA)

Experiments were conducted during development of embodiments herein to demonstrate the capacity of valproic acid (VPA) to protect organs.

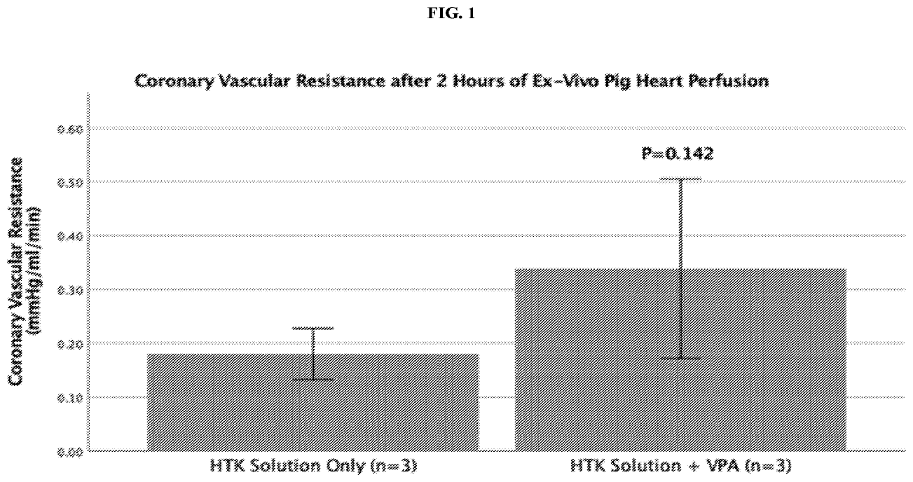

6 grams of VPA was dissolved in 2 liters of heart preservation solution (histidine-tryptophan-ketoglutarate solution, HTK) and then infused this through the aortic root of freshly sacrificed pig hearts (n=3). For the control group (n=3) only HTK solution was infused. HTK solution is one of the standard donor heart preservation solutions used clinically for heart transplantation. The pig heart was then stored in ice after mechanical arrest with HTK solution as per standard transplant protocol for a total of 6 hours. After 6 hours, the hearts were retrieved and perfused with pig blood in an ex-vivo isolated heart perfusion model. The hearts were then examined for cardiac performance. None of the VPA treated heart underwent fibrillatory arrest during ex-vivo perfusion. In contrast, 2 out of 3 hearts in the control group underwent fibrillatory arrest and expired. There was also a trend toward better maintenance of coronary vascular tone in the VPA group compared with controls (FIG. 1).

From murine heart experiments, donor hearts from C57BL/6J mice were preserved with either HTK solution or VPA+HTK solution and then stored in ice as per clinical protocols. The cold storage time was varied from 0 hour to 9 hours before reperfusing on an ex-vivo Langendorff apparatus. While cardiac reanimation was successful and comparable for both groups at up to 5 hours of cold storage, all hearts failed to demonstrate visible contraction in the HTK solution only group at 7 hours. In contrast, all donor hearts treated with VPA +HTK solution reanimated successfully at 7 hours. Even at 9 hours, up to 60% of donor hearts in the VPA +HTK solution group was able to be reanimated successfully.

For treatment of human donor hearts, 6 grams of VPA was dissolved in 2 liters of HTK preservation solution and also used 2 liters of HTK solution as control. The solutions were then infused this through the aortic root of human donor hearts (n=3). RNA-Seq was performed to study the transcriptomic effect of VPA on the human heart during cold (4° C.) storage. Total RNA was isolated from the heart tissue stored at 0 h, 4 h and 8 h time points. Gene set enrichment analysis was then performed at different time points with or without VPA treatment. As Table 1 shows, VPA administration significantly reduced the accumulation of genes related to inflammatory response during cold storage in LV. Moreover, while RV did not show significant accumulation of inflammatory response genes, VPA treatment also led to reduced expression of inflammatory response genes in RV. In particular, VPA reduced the activation of p53 proapoptotic pathway in RV during cold storage. These results indicate that VPA protects the human heart during cold storage for extended periods of time to promote normal contractile function after reperfusion in the recipient.

TABLE 1

| | Hallmark Pathway | NES | FDR |
|---|---|---|---|
| LV vs 0 h | Inflammatory response | 2.41 | 0.0018 |
| | TNF-a signaling via NFkB | 2.37 | 0.0018 |
| | Interferon gamma response | 2.16 | 0.0018 |
| VPA LV vs HTK Only | Inflammatory response | −1.47 | 0.01 |
| | Interferon gamma response | −1.65 | 0.00068 |
| | TNFa signaling via NFkB | −1.68 | 0.00068 |
| RV vs 0 h | Interferon alpha response | 1.64 | 0.052 |
| | Tgf beta signaling | 1.19 | 0.205 |
| | P53 pathway | 1.12 | 0.182 |
| VPA RV vs HTK Only | P53 pathway | −1.25 | 0.065 |
| | Inflammatory response | −1.32 | 0.040 |
| | TNFa signaling via NFkB | −1.96 | 0.0027 |

### Example 2

### Organ Preservation by Mineralocorticoid Receptor Antagonist (Spironolactone)

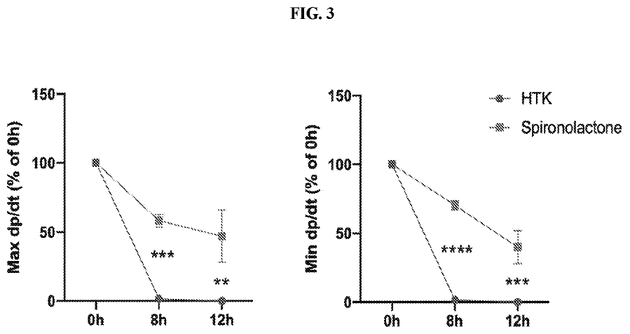

Experiments were conducted during development of embodiments herein to demonstrate the capacity of spironolactone to protect organs. Results of spironolactone experiments are depicted in FIG. 3.

### Example 3

### Organ Preservation by Aldehyde Dehydrogenase Agonist (Alda-1)

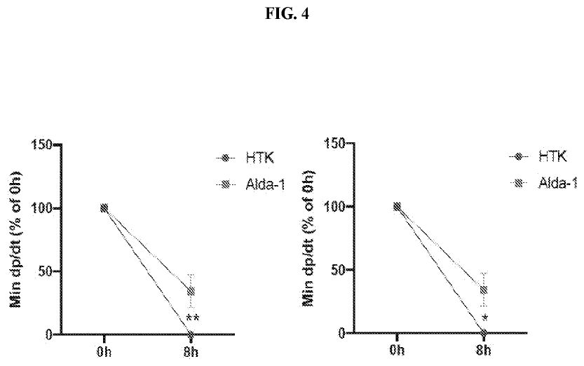

Experiments were conducted during development of embodiments herein to demonstrate the capacity of Alda-1 to protect organs. Results of Alda-1 experiments are depicted in FIG. 4.

### Example 4

### VPA Administration Improved Donor Heart Function after Prolonged Cold Storage Followed by Reperfusion

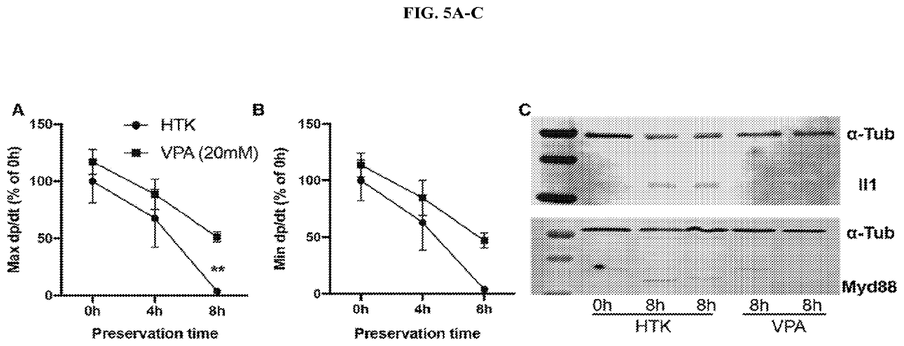

Experiments were conducted during development of embodiments herein to examine the effect of VPA on donor heart function with prolonged cold storage of donor heart. To address this, murine donor hearts were perfused with 7-8 mL HTK solution alone or HTK with 20 mM VPA and then stored the heart for 0, 4, and 8 hours. VPA dramatically improved donor heart contractility (FIG. 5A) and relaxation (FIG. 5B) after 4 h and 8 h of cold storage. Moreover, VPA suppressed the immune response of donor heart as indicated by reduced protein level of Il1 and Myd88 (FIG. 5C).

### Example 5

### Cold Storage of Donor Hearts over Progressively Longer Time Periods is Associated with Greater Reduction in Heart Function after Reperfusion, Accompanied by Progressive Activation of MR Signaling

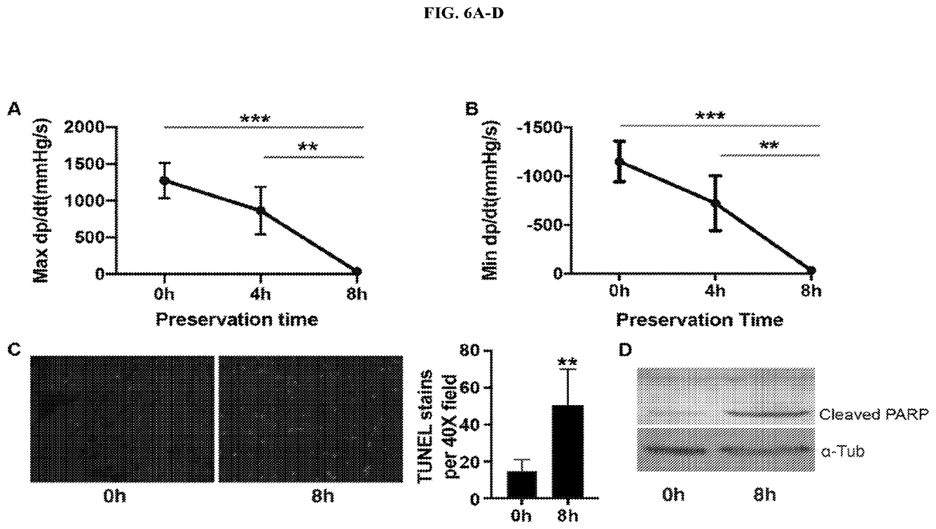

Murine donor hearts were isolated and preserved in HTK solution for 0 h, 4 h and 8 h. The cardiac hemodynamics were then examined in an ex-vivo perfusion system. Progressively longer cold storage predictably increased the risk of graft dysfunction following reperfusion (FIG. 6A-B). This was accompanied by increasing apoptotic cell death by TUNEL staining (FIG. 6C). Occurrence of cell death processes such as apoptosis with increasing storage duration is corroborated by Increased expression of cleaved poly (ADP-ribose) polymerase (PARP), a marker of cell death (FIG. 6D).

### Example 6

### Prolonged Cold Storage of Donor Hearts led to Activation of MR Signaling after Reperfusion Ex Vivo

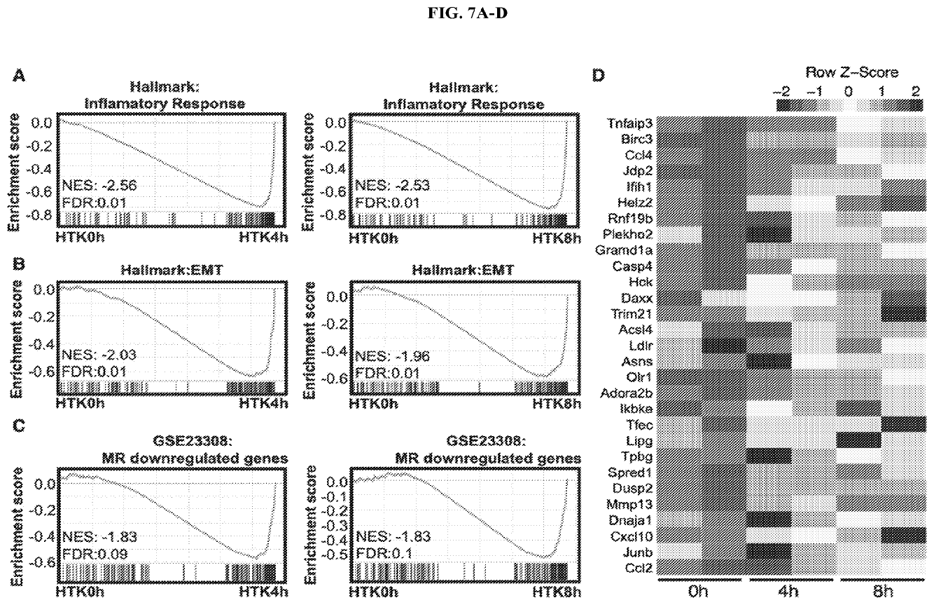

Experiments were conducted during development of embodiments herein to examine the transcriptomic profile of murine donor hearts after 0 h, 4 h and 8 h of cold storage with HTK solution followed by 90 minutes of reperfusion. Gene set enrichment analysis showed that gene sets related to immune/inflammatory response (FIG. 7A), fibrosis (FIG. 7B) as well as previously published MR activated genes (FIG. 7C) were enriched with increased cold storage duration. Increased transcription of MR target genes are shown (FIG. 7D) suggesting increasing activation of MR signaling in donor hearts during storage and reperfusion.

### Example 7

### MR is Activated in Donor Heart with Prolonged Cold Storage Followed by Reperfusion

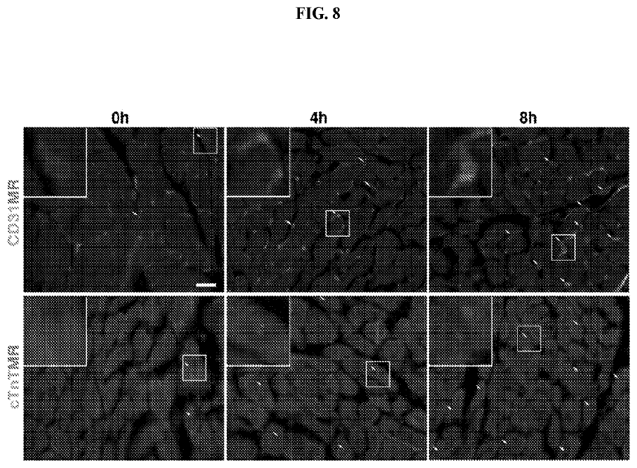

Using double staining (FIG. 8), increased MR positive staining in endothelial cells (CD31) and cardiomyocytes (cardiac troponin, cTnT) was shown with progressively longer preservation times. With donor heart reperfusion, MR staining is rare at 0 hour of storage but increases dramatically after a longer preservation duration of up to 8 hours. MR ligand aldosterone as well as its precursor deoxycorticosterone is known to be produced locally by cardiac cells.

### Example 8

### MR Bloackade using Spironolactone Greatly Improves Heart Function after Prolonged Storage of Donor Heart

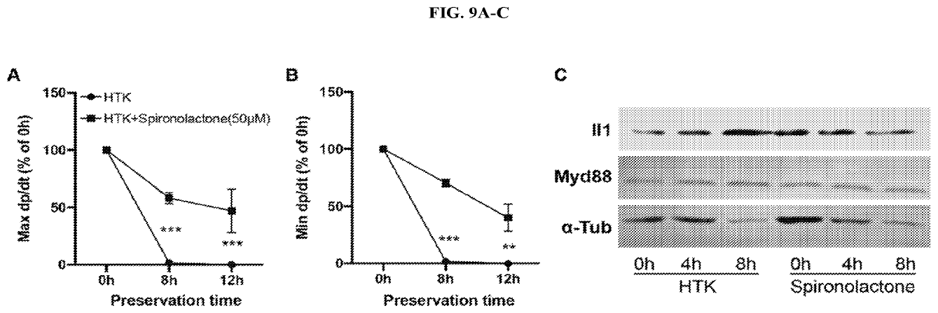

Experiments were conducted during development of embodiments herein to determine whether pharmacological inhibition of MR signaling improves the heart function after prolonged cold storage period. To address this, murine donor hearts were perfused with 7-8 mL HTK solution alone or HTK with 25 μM spironolactone and then stored the heart for 0, 8 and 12 hours. MR inhibition with spironolactone dramatically improved donor heart contractility (FIG. 9A) and relaxation (FIG. 9B) after 8 h and 12 h of cold storage. Moreover, western blot analysis also showed that spironolactone administration significantly reduced the expression of immune related gene such as Il1 and Myd88 (FIG. 9C).

### Example 9

### Canrenone (an Active Metabolite of Spironolactone) also Improves Donor Hearts Function after Extended Preservation

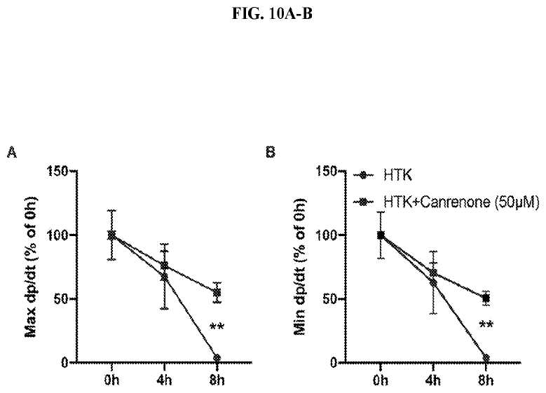

Experiments were conducted during development of embodiments herein to investigate the inhibitory role of MR signal by spironolactone, as well as the effect of canrenone, an active metabolite of spironolactone, in donor heart preservation. Canrenone significantly improves donor heart contraction (FIG. 10A) and relaxation (FIG. 10B) after 8 hours of preservation. Canrenone is approved as an intravascular formulation in European countries and this route is particularly relevant for administration during donor heart procurement.

Example 10

### Alda-1, an ALDH2 Agonist also Improves Donor Hearts Function after Extended Preservation

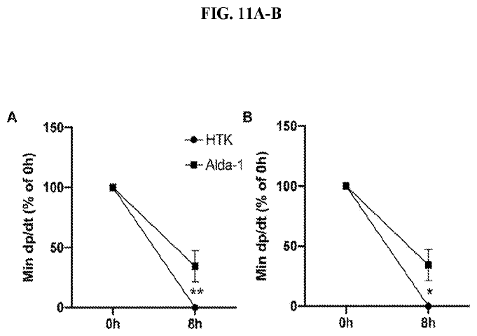

Aldh2 regulates immune response during ischemia reperfusion injury. Given the important roles of immune response of donor heart during cold storage, the effect of ALDH2 agonist Alda-1 on donor heart preservation was examined. Activation of ALDH2 by Alda-1 MR dramatically improves donor heart contractility (FIG. 11A) and relaxation (FIG. 11B) after 8 h of cold storage.

### REFERENCES

The following references, some of which are cited above by number, are herein incorporated by reference in their entireties.

1. Jackson S L, Tong X, King R J, Loustalot F, Hong Y, Ritchey M D. National Burden of Heart Failure Events in the United States, 2006 to 2014. Circ Heart Fail. 2018;11(12):e004873.

2. Hsich E M. Matching the Market for Heart Transplantation. Circ Heart Fail. 2016;9(4):e002679.

3. DeFilippis E M, Vaduganathan M, Machado S, Stehlik J, Mehra M R. Emerging Trends in Financing of Adult Heart Transplantation in the United States. JACC Heart Fail.

4. Singh S S A, Dalzell J R, Berry C, Al-Attar N. Primary graft dysfunction after heart transplantation: a thorn amongst the roses. Heart Fail Rev. 2019.

5. Costanzo M R, Dipchand A, Starling R, Anderson A, Chan M, Desai S, et al. The International Society of Heart and Lung Transplantation Guidelines for the care of heart transplant recipients. J Heart Lung Transplant. 2010;29(8):914-56.

6. Lund L H, Edwards L B, Kucheryavaya A Y, Dipchand A I, Benden C, Christie J D, et al. The Registry of the International Society for Heart and Lung Transplantation: Thirtieth Official Adult Heart Transplant Report—2013; focus theme: age. J Heart Lung Transplant. 2013;32(10):951-64.

7. Nicoara A, Ruffin D, Cooter M, Patel C B, Thompson A, Schroder J N, et al. Primary graft dysfunction after heart transplantation: Incidence, trends, and associated risk factors. Am J Transplant. 2018;18(6):1461-70.

8. DePasquale E C, Ardehali A. Primary graft dysfunction in heart transplantation. Curr Opin Organ Transplant. 2018;23(3):286-94.

9. Kittleson M M. Recent advances in heart transplantation. F1000Res. 2018;7.

10. Wei J, Chen S, Xue S, Zhu Q, Liu S, Cui L, et al. Blockade of Inflammation and Apoptosis Pathways by siRNA Prolongs Cold Preservation Time and Protects Donor Hearts in a Porcine Model. Mol Ther Nucleic Acids. 2017;9:428-39.

11. Oshima K, Takeyoshi I, Mohara J, Tsutsumi H, Ishikawa S, Matsumoto K, et al. Long-term preservation using a new apparatus combined with suppression of pro-inflammatory cytokines improves donor heart function after transplantation in a canine model. J Heart Lung Transplant. 2005;24(5):602-8.

12. Toldo S, Quader M, Salloum F N, Mezzaroma E, Abbate A. Targeting the Innate Immune Response to Improve Cardiac Graft Recovery after Heart Transplantation: Implications for the Donation after Cardiac Death. Int J Mol Sci. 2016;17(6).

13. Prabhu S D, Frangogiannis N G. The Biological Basis for Cardiac Repair After Myocardial Infarction: From Inflammation to Fibrosis. Circ Res. 2016;119(1):91-112.

14. Arslan F, Smeets M B, O'Neill L A, Keogh B, McGuirk P, Timmers L, et al. Myocardial ischemia/reperfusion injury is mediated by leukocytic toll-like receptor-2 and reduced by systemic administration of a novel anti-toll-like receptor-2 antibody. Circulation. 2010;121(1):80-90.

15. O'Brien L C, Mezzaroma E, Van Tassell B W, Marchetti C, Carbone S, Abbate A, et al. Interleukin-18 as a therapeutic target in acute myocardial infarction and heart failure. Mol Med. 2014;20:221-9.

16. Schroder J, ; D'Alessandro, F E,; Boeve, T,; Tang, P,; Liao, K,; Wang, I,: Anyanwu, A,; Shah, A,: Mudy, K,; Soltesz, E,; Smith, J W. Successful Utilization of Extended Criteria Donor (ECD) Hearts for Transplantation—Results of the OCS™Heart EXPAND Trial to Evaluate the Effectiveness and Safety of the OCS Heart System to Preserve and Assess ECD Hearts for Transplantation. The Journal of Heart and Lung Transplantation. 2019;38(4):542.

17. Fu F, Li Y, Qian S, Lu L, Chambers F, Starzl T E, et al. Costimulatory molecule-deficient dendritic cell progenitors (MHC class II+, CD80dim, CD86-) prolong cardiac allograft survival in nonimmunosuppressed recipients. Transplantation. 1996;62(5):659-65.

18. Chateauvieux S, Morceau F, Dicato M, Diederich M. Molecular and therapeutic potential and toxicity of valproic acid. J Biomed Biotechnol. 2010;2010.

19. Wu S Y, Tang S E, Ko F C, Wu G C, Huang K L, Chu S J. Valproic acid attenuates acute lung injury induced by ischemia-reperfusion in rats. Anesthesiology. 2015;122(6):1327-37.

20. Costalonga E C, Silva F M, Noronha I L. Valproic Acid Prevents Renal Dysfunction and Inflammation in the Ischemia-Reperfusion Injury Model. Biomed Res Int.

21. Suda S, Katsura K, Kanamaru T, Saito M, Katayama Y. Valproic acid attenuates ischemia-reperfusion injury in the rat brain through inhibition of oxidative stress and inflammation. Eur J Pharmacol. 2013;707(1-3):26-31.

22. Xuan A, Long D, Li J, Ji W, Hong L, Zhang M, et al. Neuroprotective effects of valproic acid following transient global ischemia in rats. Life Sci. 2012;90(11-12):463-8.

23. Lee T M, Lin M S, Chang N C. Inhibition of histone deacetylase on ventricular remodeling in infarcted rats. Am J Physiol Heart Circ Physiol. 2007;293(2):H968-77.

24. Kochanek A R, Fukudome E Y, Li Y, Smith E J, Liu B, Velmahos G C, et al. Histone deacetylase inhibitor treatment attenuates MAP kinase pathway activation and pulmonary inflammation following hemorrhagic shock in a rodent model. J Surg Res. 2012;176(1):185-94.

25. Li Y, Alam H B. Modulation of acetylation: creating a pro-survival and anti-inflammatory phenotype in lethal hemorrhagic and septic shock. J Biomed Biotechnol. 2011;2011:523481.

26. Zhao L, Chen C N, Hajji N, Oliver E, Cotroneo E, Wharton J, et al. Histone deacetylation inhibition in pulmonary hypertension: therapeutic potential of valproic acid and suberoylanilide hydroxamic acid. Circulation. 2012;126(4):455-67.

27. Lan B, Hayama E, Kawaguchi N, Furutani Y, Nakanishi T. Therapeutic efficacy of valproic acid in a combined monocrotaline and chronic hypoxia rat model of severe pulmonary hypertension. PLoS One. 2015;10(1):e0117211.

28. Zhang Z, Zhang ZY, Fauser U, Schluesener H J. Valproic acid attenuates inflammation in experimental autoimmune neuritis. Cell Mol Life Sci. 2008;65(24):4055-65.

29. Ximenes J C, de Oliveira Goncalves D, Siqueira R M, Neves K R, Santos Cerqueira G, Correia A O, et al. Valproic acid: an anticonvulsant drug with potent antinociceptive and anti-inflammatory properties. Naunyn Schmiedebergs Arch Pharmacol. 2013;386(7):575-87.

30. Hosgorler F, Keles D, Tanriverdi-Akhisaroglu S, Inanc S, Akhisaroglu M, Cankurt U, et al. Anti-inflammatory and Anti-apoptotic Effect of Valproic Acid and Doxycycline Independent from MMP Inhibition in Early Radiation Damage. Balkan Med J. 2016;33(5):488-95.

31. Long J, Chang L, Shen Y, Gao W H, Wu Y N, Dou H B, et al. Valproic Acid Ameliorates Graft-versus-Host Disease by Downregulating Th1 and Th17 Cells. J Immunol. 2015;195(4):1849-57.

1. A preservation fluid comprising a solution of:
(a) a mineralocorticoid receptor antagonist, aldehyde dehydrogenase agonist, and/or histone deacetylase inhibitor;
(b) water;
(c) buffer;
(d) physiologically-relevant concentrations of cations and anions; and having an osmolarity of 250-500 mOsm/L.

2. The preservation fluid of claim 1, wherein the mineralocorticoid receptor antagonist, aldehyde dehydrogenase agonist, and/or histone deacetylase inhibitor is present at a concentration of 1-100 mM.

3. The preservation fluid of claim 2, wherein the mineralocorticoid receptor antagonist, aldehyde dehydrogenase agonist, and/or histone deacetylase inhibitor is present at a concentration of 5-50 mM.

4. The preservation fluid of claim 3, wherein the mineralocorticoid receptor antagonist, aldehyde dehydrogenase agonist, and/or histone deacetylase inhibitor is present at a concentration of 10-30 mM.

5. The preservation fluid of claim 4, wherein the mineralocorticoid receptor antagonist, aldehyde dehydrogenase agonist, and/or histone deacetylase inhibitor is present at a concentration of 15-25 mM.

6. The preservation fluid of claim 1, wherein the cations and anions are selected from potassium, calcium, magnesium, chloride, bicarbinate, hydroxide, and sulfate ions.

7. The preservation fluid of claim 1, wherein the cations and anions are independently present at 0.01 to 200 mM.

8. The preservation fluid of claim 1, further comprising one or more impermeants, antioxidants, and/or other components.

9. The preservation fluid of claim 8, comprising one or more impermeants selected from lucose, LactoB, raffinose, mannitol, dextran, and albumin.

10. The preservation fluid of claim 8, comprising one or more antioxidants selected from allopurinol (AlloP), glutathione (GSH), tryptophan (Trp), and mannitol.

11. The preservation fluid of claim 8, comprising other components selected from α-ketoglutarate, dextran, blood, heparin, glucose, adenosine, and an amiloride-containing compound.

12. The preservation fluid of claim 1, wherein the buffer is selected from phosphate, bicarbinate, and histidine.

13. The preservation fluid of claim 1, comprising sodium and potassium cations, chloride anions, glucose, phosphate and bicarbonate buffers, and an osmolatity of between 300 and 450 mOsm/L.

14. The preservation fluid of claim 1, comprising sodium, potassium, and magnesium cations, chloride anions, phosphate buffer, lactobionate, raffinose, hydroxyethyl starch, allopurinol, glutathione, and an osmolatity of between 250 and 400 mOsm/L.

15. The preservation fluid of claim 1, comprising sodium, potassium, calcium, and magnesium cations, chloride anions, histidine buffer, tryptophan, mannitol, α-ketoglutarate, and an osmolatity of between 250 and 400 mOsm/L.

16. The preservation fluid of claim 1, comprising sodium and potassium cations, histidine buffer, lactobionate, mannitol, glutathione, and an osmolatity of between 250 and 400 mOsm/L.

17. The preservation fluid of claim 1, comprising sodium, potassium, calcium, and magnesium cations, chloride anions, phosphate buffer, dextran, sulfate, and an osmolatity of between 200 and 400 mOsm/L.

18. The preservation fluid of claim 1, comprising sodium and potassium cations, blood, heparin, mannitol, albumin, and an osmolatity of between 400 and 500 mOsm/L.

19. The preservation fluid of claim 1, comprising sodium, potassium, calcium, and magnesium cations, chloride anions, bicarbonate buffer, and an osmolatity of between 200 and 400 mOsm/L.

20. The preservation fluid of one of claims 1-19, comprising a mineralocorticoid receptor antagonist.

21. The preservation fluid of claim 20, wherein the mineralocorticoid receptor antagonist is selected from spironolactone, eplerenone, canrenoic acid, canrenone, and drospirenone.

22. The preservation fluid of one of claims 1-21, comprising an aldehyde dehydrogenase agonist.

23. The preservation fluid of claim 20, wherein the aldehyde dehydrogenase agonist is selected from Alda-1, Alda-89, Alda-52, Alda-59, Alda-72, Alda-71, Alda-53, Alda-54, Alda-61, Alda-60, Alda-66, Alda-65, Alda-64, and Alda-84.

24. The preservation fluid of one of claims 1-23, comprising a histone deacetylase inhibitor.

25. The preservation fluid of claim 24, wherein the histone deacetylase inhibitor is selected from a hydroxamic acid, depsipeptide, benzamide; electrophilic ketone, phenylbutyrate and valproic acid, nicotinamide, and NA derivatives.

26. A method of preserving an organ or tissue comprising exposing the organ to a preservation fluid of one of claims 1-25.

27. The method of claim 26 comprising perfusing the organ with the preservation fluid.

28. The method of claim 26, further comprising storing the organ at a temperature between −10° C. and 10° C.

29. The method of claim 26 wherein the organ is selected from a heart, kidneys, liver, lungs, pancreas, intestine, and thymus

30. The method of claim 26 wherein the tissue is selected from bones, tendons, corneae, skin, heart valves, nerves and veins.

31. The method of claim 26, further comprising removing the organ or tissue from a donor.

32. The method of claim 31, wherein the organ or tissue is exposed to the preservation fluid after being removed from the donor.

33. The method of claim 26, wherein the organ is a heart.

34. The method of claim 33, further comprising arresting the heart with a cardioplegic solution prior to removal from the donor.

35. A method of preserving an organ or tissue comprising exposing the organ to a preservation fluid comprising mineralocorticoid receptor antagonist, aldehyde dehydrogenase agonist, and/or histone deacetylase inhibitor.

36. The method of claim 35, wherein the mineralocorticoid receptor antagonist, aldehyde dehydrogenase agonist, and/or histone deacetylase inhibitor is present at a concentration of 1-100 mM.

37. The method of claim 36, wherein the mineralocorticoid receptor antagonist, aldehyde dehydrogenase agonist, and/or histone deacetylase inhibitor is present at a concentration of 5-50 mM.

38. The method of claim 37, wherein the mineralocorticoid receptor antagonist, aldehyde dehydrogenase agonist, and/or histone deacetylase inhibitor is present at a concentration of 10-30 mM.

39. The method of claim 38, wherein the mineralocorticoid receptor antagonist, aldehyde dehydrogenase agonist, and/or histone deacetylase inhibitor is present at a concentration of 15-25 mM.

40. The method of claim 35, the preservation fluid further comprising one or more of physiologically-relevant concentrations of cations and anions, impermeants, antioxidants, buffer, and other components selected from α-ketoglutarate, dextran, blood, heparin, glucose, adenosine, and an amiloride-containing compound

41. The method of claim 35 comprising perfusing the organ with the preservation fluid.

42. The method of claim 35, further comprising storing the organ at a temperature between −10° C. and 10° C.

43. The method of claim 35 wherein the organ is selected from a heart, kidneys, liver, lungs, pancreas, intestine, and thymus

44. The method of claim 35 wherein the tissue is selected from bones, tendons, corneae, skin, heart valves, nerves and veins.

45. The method of claim 35, further comprising removing the organ or tissue from a donor.

46. The method of claim 45, wherein the organ or tissue is exposed to the preservation fluid after being removed from the donor.

47. The method of claim 35, wherein the organ is a heart.

48. The method of claim 47, further comprising arresting the heart with a cardioplegic solution prior to removal from the donor.

49. The method of one of claims 35-48, comprising a mineralocorticoid receptor antagonist.

50. The method of claim 49, wherein the mineralocorticoid receptor antagonist is selected from spironolactone , eplerenone, canrenoic acid, canrenone, and drospirenone.

51. The method of one of claims 35-50, comprising an aldehyde dehydrogenase agonist.

52. The method of claim 51, wherein the aldehyde dehydrogenase agonist is selected from Alda-1, Alda-89, Alda-52, Alda-59, Alda-72, Alda-71, Alda-53, Alda-54, Alda-61, Alda-60, Alda-66, Alda-65, Alda-64, and Alda-84.

53. The method of one of claims 35-52, comprising a histone deacetylase inhibitor.

54. The method of claim 52, wherein the histone deacetylase inhibitor is selected from a hydroxamic acid, depsipeptide, benzamide; electrophilic ketone, phenylbutyrate and valproic acid, nicotinamide, and NA derivatives.
